(19) United States
(12) Patent Application Publication
(10) Pub. No.: US 2026/0225201 A1
(43) Pub. Date: Aug. 6, 2026

(54) COOLANT SYSTEM

(71) Applicant: FANUC CORPORATION, Yamanashi (JP)

(72) Inventor: Ryutaro ISHIKAWA, Minamitsuru-gun (JP)

(21) Appl. No.: 19/151,782

(22) PCT Filed: Feb. 9, 2023
(86) PCT No.: PCT/JP2023/004395

§ 371 Date: Jul. 29, 2025

(51) Int. Cl. B23Q 11/10; B23Q 11/00

(52) U.S. Cl. CPC B23Q 11/1069; B23Q 11/0075

(57) ABSTRACT

The present invention provides a coolant system comprising a separation device and a storage device. The storage device comprises: a storage container which is disposed on a foundation and in which machining debris is stored; and a cover to which the separation device is connected and which covers an opening in the storage container.

### CROSS-REFERENCE TO RELATED APPLICATIONS

This application is a national phase entry under 35 U.S.C. 371 of PCT International Application No. PCT/JP2023/004395, filed Feb. 9, 2023, the disclosure of this application is expressly incorporated herein by reference in its entirety.

### TECHNICAL FIELD

The present disclosure relates to a coolant system.

### BACKGROUND ART

JP 2014-094431 A discloses a working fluid purification system. The working fluid purification system is provided with a circulation path. The circulation path is a path that guides the working fluid stored in a tank to a machining device and guides the working fluid discharged from the machining device to the tank. A centrifugal separator is provided in the circulation path. The centrifugal separator uses centrifugal force to separate fine substances contained in the working fluid discharged from the machining device. The fine substances separated by the centrifugal separator are discharged to a collection unit via a discharge pipe connected to the centrifugal separator.

In general, a structure in which a collection unit is suspended from a centrifugal separator is known.

### SUMMARY OF THE INVENTION

However, in the case where the collection unit is suspended from the centrifugal separator, the weight of the collection unit needs to be a weight that can withstand the suspension. Further, the weight of the collection unit needs to be a weight that allows the operator to hold the collection unit. Therefore, there is a problem that the capacity of the collection unit cannot be increased to a certain level or more.

An aspect of the present disclosure is a coolant system that separates swarf generated by machining of a machine tool, from a first liquid that is a liquid containing the swarf, and supplies, to the machine tool, a second liquid that is the liquid from which the swarf has been separated, the coolant system comprising: a separation device configured to separate, from the first liquid pumped up from a first liquid tank configured to store the first liquid, the swarf contained in the first liquid; and a storage device configured to store the swarf separated by the separation device, wherein the storage device includes: a storage container disposed on a base and configured to store the swarf; and a cover to which the separation device is connected, the cover being configured to cover an opening portion of the storage container.

### BRIEF DESCRIPTION OF DRAWINGS

FIG. 1 is a schematic diagram of a coolant system;

FIG. 2 is a diagram showing a separation device and a storage device;

FIG. 3 is a diagram showing the separation device and the storage device with a cover opened;

FIG. 4 is a diagram showing the separation device and the storage device according to a first modification;

FIG. 5 is a diagram showing the separation device and the storage device according to a second modification;

FIG. 6 is a diagram showing the separation device and the storage device according to a third modification;

FIG. 7 is a diagram showing the separation device and the storage device according to a fourth modification;

FIG. 8 is a diagram showing the separation device and the storage device with the cover opened according to the fourth modification;

FIG. 9 is a diagram showing the separation device and the storage device according to a fifth modification;

FIG. 10 is a diagram showing the separation device and the storage device with the cover opened according to the fifth modification; and

FIG. 11 is a diagram showing the separation device and the storage device according to a sixth modification.

### DETAILED DESCRIPTION OF THE INVENTION

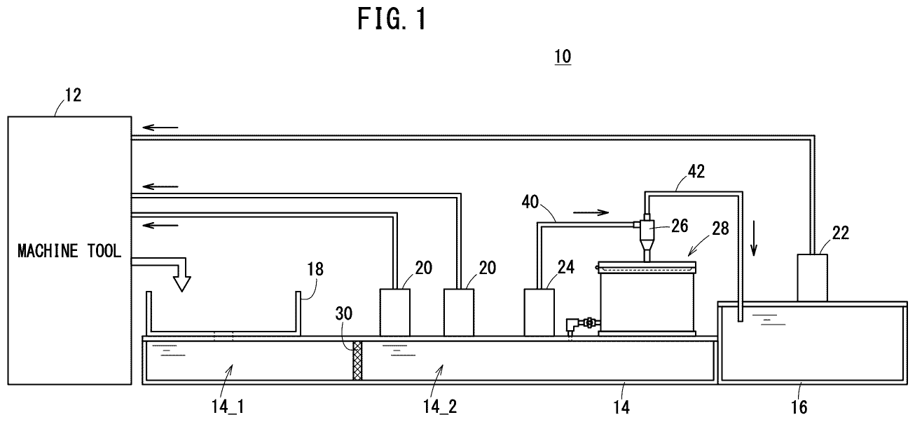

FIG. 1 is a schematic diagram of a coolant system 10. The coolant system 10 is a system that separates swarf generated by machining of a machine tool 12, from a coolant containing the swarf, and supplies the coolant from which the swarf has been separated to the machine tool 12. Examples of the machine tool 12 include a cutting machine, a lathe machine, and a grinding machine. The coolant is a liquid. In general, a water-soluble liquid that is used by being dissolved in water is used as the coolant. When machining is performed by the machine tool 12, the coolant is used to improve machining performance, to cool machining heat, or to discharge swarf generated by machining to the outside of the machine tool.

The coolant system 10 includes a first liquid tank 14, a second liquid tank 16, a coolant receiving member 18, a first liquid pressure pump 20, a second liquid pressure pump 22, a feed pump 24, a separation device 26, and a storage device 28.

The first liquid tank 14 is a tank that stores a coolant containing swarf. The first liquid tank 14 is partitioned into a dirty liquid tank 14_1 and a primary clean liquid tank 14_2 by a porous filter member 30. The dirty liquid tank 14_1 and the primary clean liquid tank 14_2 communicate with each other via the porous filter member 30. The porous filter member 30 partitions the first liquid tank 14 into the dirty liquid tank 14_1 and the primary clean liquid tank 14_2. The porous filter member 30 captures the swarf contained in the coolant stored in the dirty liquid tank 14_1.

The second liquid tank 16 is a secondary clean liquid tank that stores the coolant from which the swarf has been separated by the separation device 26. The coolant stored in the second liquid tank 16 contains almost no swarf, which is much less than the swarf contained in the coolant stored in the primary clean liquid tank 14_2.

The coolant receiving member 18 is a member for receiving the coolant discharged from the machine tool 12 and feeding the coolant into the dirty liquid tank 14_1. The coolant discharged from the machine tool 12 contains swarf. The coolant receiving member 18 is installed on, for example, a top plate of the first liquid tank 14.

The first liquid pressure pump 20 is a pump that pressure-feeds the coolant stored in the primary clean liquid tank 14_2 to the machine tool 12. The first liquid pressure pump 20 is installed on, for example, the top plate of the first liquid tank 14. In FIG. 1, the number of the first liquid pressure pumps 20 is two, but may be one or three or more. The coolant pressure-fed to the machine tool 12 by the first liquid pressure pump 20 is supplied to, for example, a cleaning nozzle in order to discharge the swarf from the inside of the machine tool 12. In this case, the coolant is discharged to a splash guard or the like of the machine tool 12.

The second liquid pressure pump 22 is a pump that pressure-feeds the coolant stored in the second liquid tank 16 to the machine tool 12. The second liquid pressure pump 22 is installed on, for example, a top plate of the second liquid tank 16. In FIG. 1, the number of the second liquid pressure pumps 22 is one, but may be two or more. The coolant pressure-fed to the machine tool 12 by the second liquid pressure pump 22 is supplied to, for example, a through hole formed in a spindle of the machine tool 12. In this case, the coolant is discharged to a machining portion of the tool from a through hole of a tool attached to the spindle.

The feed pump 24 is a pump that pressure-feeds the coolant stored in the primary clean liquid tank 14_2 to the separation device 26. The feed pump 24 is installed on, for example, the top plate of the first liquid tank 14.

The first liquid pressure pump 20, the second liquid pressure pump 22, and the feed pump 24 may be of a positive-displacement type or a non-positive-displacement type.

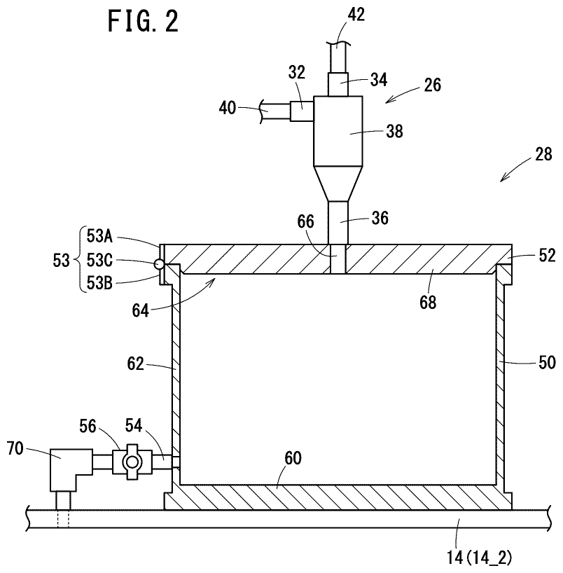

FIG. 2 is a diagram showing the separation device 26 and the storage device 28. The separation device 26 is a separator that separates swarf from a coolant containing the swarf. The separation device 26 may be a cyclone filter. The separation device 26 includes an input unit 32, a clean liquid output unit 34, a dirty liquid output unit 36, and a main body unit 38.

The input unit 32 is provided on the upper side surface portion of the main body unit 38. The input unit 32 is connected to the feed pump 24 via an input conduit 40. The input unit 32 is formed so that the input conduit 40 is attachable thereto and detachable therefrom.

The clean liquid output unit 34 is provided on the upper portion of the main body unit 38. The clean liquid output unit 34 communicates with the second liquid tank 16 via an output conduit 42. The clean liquid output unit 34 is formed so that the output conduit 42 is attachable thereto and detachable therefrom.

The dirty liquid output unit 36 is provided on the lower portion of the main body unit 38. The dirty liquid output unit 36 communicates with a storage container 50 of the storage device 28. The dirty liquid output unit 36 is fixed to the storage device 28.

The main body unit 38 separates the swarf from the coolant. In the case where the separation device 26 is a cyclone filter, the main body unit 38 separates the swarf from the coolant by using centrifugal force. In this case, the coolant flowing in from the input unit 32 rotates in the main body unit 38. The swarf contained in the coolant is precipitated downward while being aggregated near the outer wall of the cyclone filter by centrifugal force generated due to the rotation, and flows out from the dirty liquid output unit 36 together with a portion of the coolant. As a result, the swarf is hardly contained in the center of the cyclone filter, and clean coolant is discharged from the clean liquid output unit 34.

The storage device 28 is a device that stores the swarf separated by the separation device 26. The storage device 28 includes the storage container 50, a cover 52, a drain member 54, and a valve 56.

The storage container 50 is a container that stores the swarf discharged together with the coolant from the dirty liquid output unit 36. The storage container 50 is disposed on a base. The base may be a floor in a room or may be a field outside.

The storage container 50 includes a bottom wall 60, a side wall 62, and an opening portion 64. The opening portion 64 is formed in an upper portion on the opposite side from the bottom wall 60. The storage container 50 may be formed such that the inside of the storage container 50 is visible from the outside of the storage container 50. For example, the entire side wall 62 is formed of a transparent polymer, glass, or the like. Alternatively, a window portion may be formed in a part of the side wall 62. In the case where the storage container 50 is formed such that the inside of the storage container 50 is visible from the outside of the storage container 50, the operator can check the storage state of the storage container 50 without looking into the inside of the storage container 50 from the opening portion 64.

The cover 52 covers the opening portion 64 of the storage container 50. The separation device 26 is connected to the cover 52. The cover 52 includes a through hole 66. The through hole 66 allows communication between the opening portion 64 of the storage container 50 and the dirty liquid output unit 36 of the separation device 26. The dirty liquid output unit 36 of the separation device 26 is connected to the surface of the cover 52 on the side opposite to the opening portion 64 of the storage container 50. The swarf flowing out from the dirty liquid output unit 36 together with the coolant flows into the storage container 50 via the through hole 66.

The coolant system 10 may include a support member 53. The support member 53 movably supports the cover 52 to open and close the opening portion 64 of the storage container 50. The support member 53 movably couples the cover 52 to the storage container 50. Examples of the support member 53 include a hinge. The support member 53 includes a first fixing portion 53A, a second fixing portion 53B, and a shaft 53C.

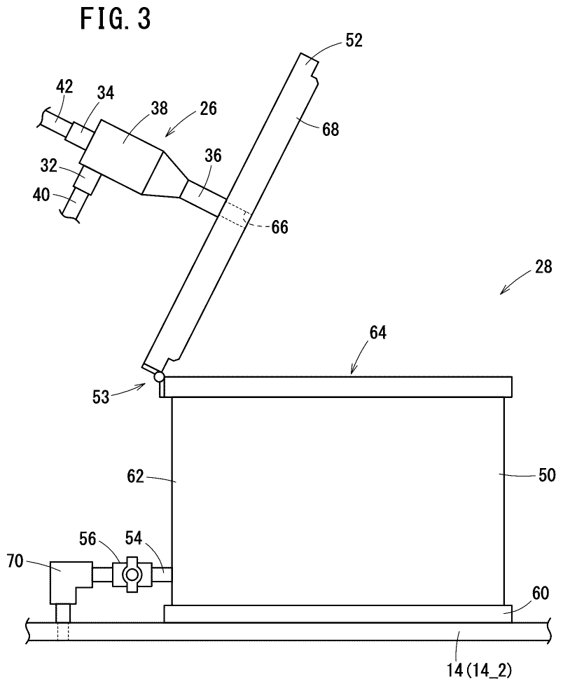

The first fixing portion 53A is fixed to the cover 52. The second fixing portion 53B is fixed to the storage container 50. The shaft 53C pivotably couples the first fixing portion 53A and the second fixing portion 53B. The shaft 53C is disposed parallel to the base surface on which the storage container 50 is disposed. When the cover 52 pivots in a first direction about the shaft 53C, the opening portion 64 is opened (see FIG. 3). On the other hand, when the cover 52 pivots in a second direction opposite to the first direction about the shaft 53C, the opening portion 64 is closed by the cover 52 (see FIG. 2).

FIG. 3 is a diagram showing the separation device 26 and the storage device 28 with the cover 52 opened. The cover 52 may include a protruding portion 68 protruding from the bottom surface of the cover 52. The level of the liquid such as the coolant stored in the storage container 50 is restricted by the protruding portion 68. As a result, when the cover 52 is opened in a state where the storage container 50 is filled with a liquid such as a coolant, the liquid such as the coolant can be prevented from leaking from the opening portion 64.

The drain member 54 is provided in the storage container 50 so as to be able to communicate with the inside of the storage container 50. The drain member 54 discharges a liquid such as a coolant from the storage container 50. The drain member 54 may be a drain pipe connected to the storage container 50. In the present embodiment, an example in which the drain member 54 is a drain pipe is shown in each drawing. One end portion of the drain pipe penetrates through the lower portion of the side wall 62 of the storage container 50 and opens to the inside of the storage container 50. The other end portion of the drain pipe is connected to a first connection portion of a tube fitting 70. A conduit communicating with the primary clean liquid tank 14_2 is connected to a second connection portion of the tube fitting 70.

The valve 56 opens and closes the drain member 54. In the present embodiment, the valve 56 is closed during operation of the separation device 26. On the other hand, in the present embodiment, the valve 56 is opened in an arbitrary opening period during the stop of the separation device 26. The opening period is a period for performing cleaning, maintenance work, or the like of the storage container 50. When the valve 56 is opened, the coolant inside the storage container 50 is discharged to the primary clean liquid tank 14_2 of the first liquid tank 14.

The valve 56 may be replaced with a cap or a plug that closes the end portion of the drain member 54 communicating with the storage container 50. In this case, the cap or the plug is attached to the end portion of the drain member 54 during periods other than the opening period. On the other hand, the cap or the plug is removed from the end portion of the drain member 54 during the opening period.

As described above, in the storage device 28 of the present embodiment, the storage container 50 in which the swarf is stored is disposed on the base. Compared to a case where a collection unit for collecting swarf is suspended from the separation device 26, the capacity capable of storing the swarf can be increased regardless of the weight of the storage container 50. As a result, the cleaning frequency can be reduced. Further, the separation device 26 is connected to the cover 52 that covers the opening portion 64 of the storage container 50. Consequently, the swarf stored in the storage container 50 can be taken out from the storage container 50 without detaching the separation device 26. As a result, cleaning workability can be improved.

In the case where the cover 52 is attached to the storage container 50 so as to be pivotable about the shaft 53C, the opening portion 64 can be opened without separating the cover 52 from the storage container 50. As a result, the work of stably placing the separated cover on a place is eliminated, and the workload can be reduced.

Further, in the present embodiment, the drain member 54 is provided in the storage container 50 so as to be able to communicate with the inside of the storage container 50. The drain member 54 is opened and closed by the valve 56. Therefore, it is possible to prevent the swarf and the coolant from flowing out of the storage container 50 during the operation of the separation device 26. Further, the swarf, the coolant, and the like can be discharged from the storage container 50 only during a period of cleaning, maintenance work, or the like of the storage container 50.

The above-described embodiment may be modified in the following manner. In the following modifications, description overlapping with that of the embodiment will be omitted. Further, in the drawings used in the following modifications, the same components as those described in the embodiment are denoted by the same reference numerals.

### Modification 1

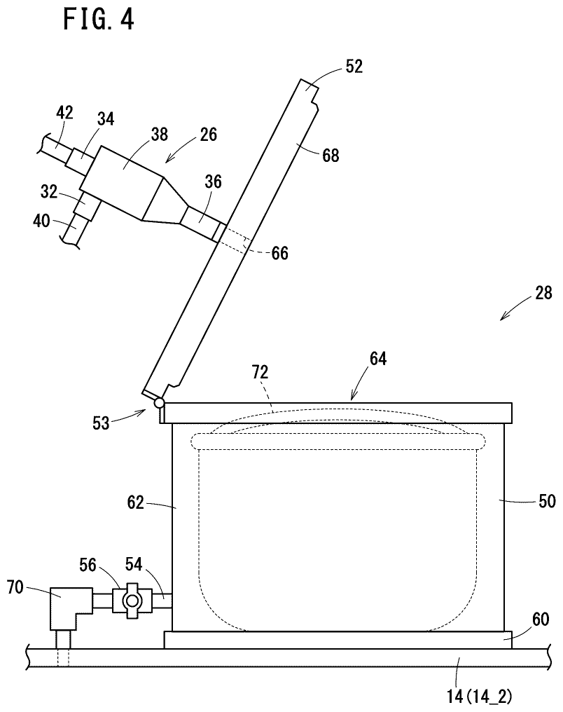

FIG. 4 is a diagram showing the separation device 26 and the storage device 28 according to a first modification. In the present modification, the storage device 28 further includes a bag 72.

The bag 72 is a bag in which the swarf is put. The bag 72 is disposed inside the storage container 50. The bag 72 is removable from the inside of the storage container 50.

Therefore, the swarf can be easily taken out from the storage container 50 during cleaning or the like, and the inside of the storage container 50 can be kept clean.

The bag 72 may be a mesh bag having holes through which the coolant discharged together with the swarf can pass. In this case, the swarf can be efficiently collected by draining the coolant in the storage container 50 from the drain member 54 during cleaning or the like.

### Modification 2

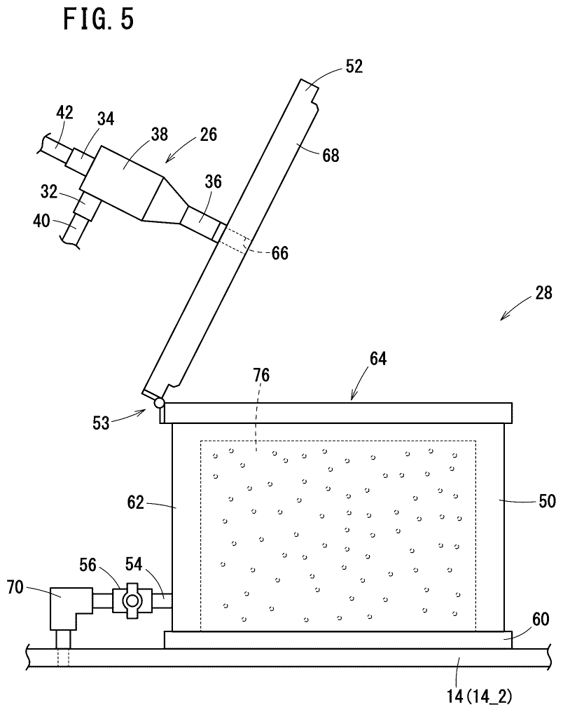

FIG. 5 is a diagram showing the separation device 26 and the storage device 28 according to a second modification. In the present modification, the storage device 28 further includes a porous filter member 76.

The porous filter member 76 is a member capable of capturing the swarf. The porous filter member 76 is disposed inside the storage container 50. The porous filter member 76 is removable from the inside of the storage container 50.

Therefore, the swarf can be efficiently collected by draining the coolant in the storage container 50 from the drain member 54 during cleaning.

The porous filter member 76 may be replaced with a magnet capable of attracting the swarf. In this case as well, the swarf can be efficiently collected by draining the coolant in the storage container 50 from the drain member 54 during cleaning or the like.

It should be noted that, in this modification, the valve 56 may be opened during the operation period of the separation device 26 in order to allow the porous filter member 76 to capture the swarf.

### Modification 3

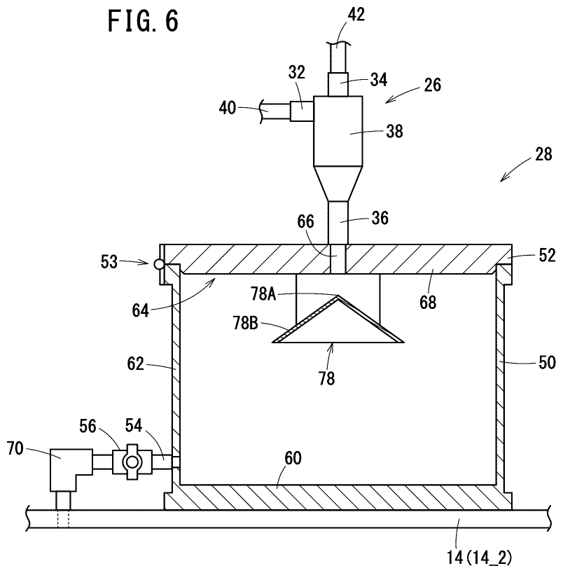

FIG. 6 is a diagram showing the separation device 26 and the storage device 28 according to a third modification. In the present modification, the storage device 28 further includes a guide member 78.

The guide member 78 is a member that guides the swarf discharged from the dirty liquid output unit 36 of the separation device 26 via the through hole 66 of the cover 52. The guide member 78 may be attached to the storage container 50 or may be attached to the cover 52.

The guide member 78 includes a top portion 78A and an outer peripheral portion 78B connected to the top portion 78A. The outer peripheral portion 78B extends radially from the top portion 78A toward the edge of the outer peripheral portion 78B. Further, the outer peripheral portion 78B is inclined from the top portion 78A toward the edge of the outer peripheral portion 78B. For example, the guide member 78 is formed in a conical shape, and the top portion 78A is disposed directly below the through hole 66 of the cover 52.

By using the top portion 78A and the outer peripheral portion 78B, the guide member 78 disperses the swarf discharged from the separation device 26. Therefore, it is possible to suppress a situation in which the swarf is intensively deposited inside the storage container 50. Further, it is possible to reduce the swirling up of the swarf that is deposited inside the storage container 50.

### Modification 4

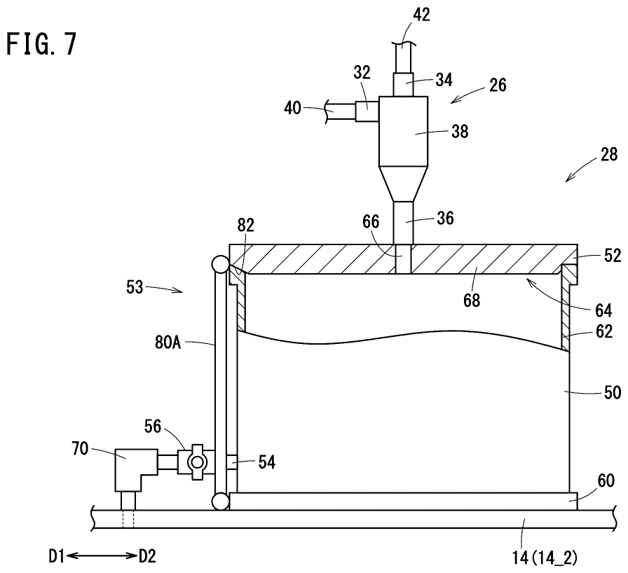

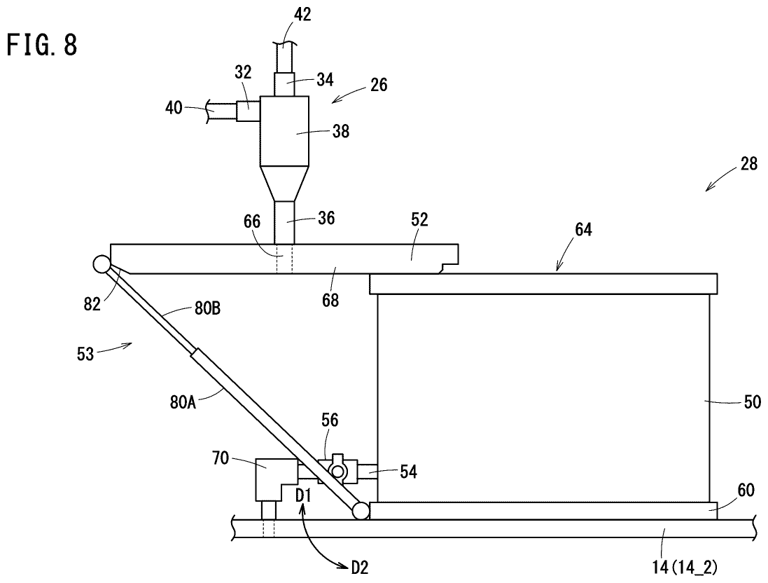

FIG. 7 is a diagram showing the separation device 26 and the storage device 28 according to a fourth modification. FIG. 8 is a diagram showing the separation device 26 and the storage device 28 with the cover 52 opened according to the fourth modification. In the present modification, the structure of the support member 53 is different from that of the embodiment.

The support member 53 includes a housing portion 80A and a sliding portion 80B (FIG. 8). The housing portion 80A includes a hole capable of housing the sliding portion 80B. The sliding portion 80B is attached to the housing portion 80A so as to be slidable in the hole of the housing portion 80A. A first end portion of the housing portion 80A is pivotably connected to the storage container 50. A second end portion of the housing portion 80A is formed as an inlet/outlet of the sliding portion 80B. A first end portion of the sliding portion 80B is slidably connected within the hole of the housing portion 80A. A second end portion of the sliding portion 80B is pivotably connected to the cover 52.

When the housing portion 80A pivots in a first direction D1 approaching the storage container 50, the sliding portion 80B slides into the hole of the housing portion 80A, and the sliding portion 80B is shortened. As a result, the opening portion 64 is closed by the cover 52 (see FIG. 7).

On the other hand, when the housing portion 80A pivots in a second direction D2 away from the storage container 50, the sliding portion 80B slides from the inside of the hole of the housing portion 80 A to the outside, and the sliding portion 80B extends.

In this manner, in the present modification, the cover 52 is attached to the storage container 50 so as to be slidable along the opening surface of the opening portion 64 of the storage container 50. As a result, compared to the configuration of the support member 53 in the embodiment, the cover 52 can be smoothly opened and closed even when the weight of the cover 52 is large.

In the cover 52 of the present modification, an inclined portion 82 is formed at an end portion of the protruding portion 68. The inclined portion 82 is inclined such that the amount of protrusion from the bottom surface of the cover 52 decreases toward the terminal end. This allows the cover 52 to slide smoothly.

### Modification 5

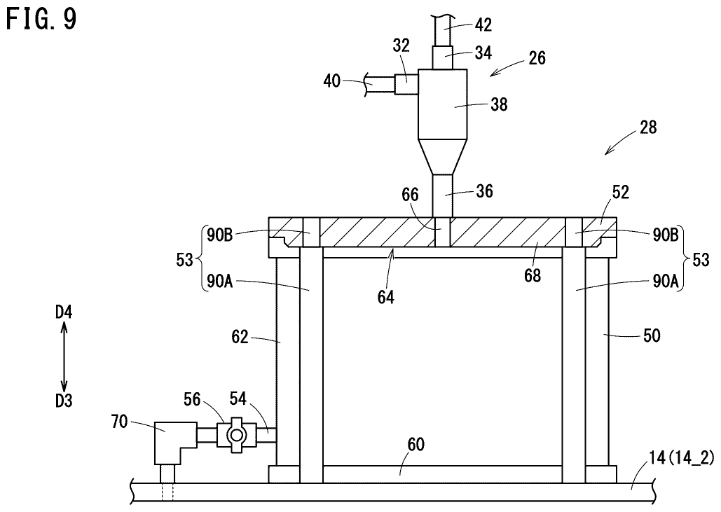

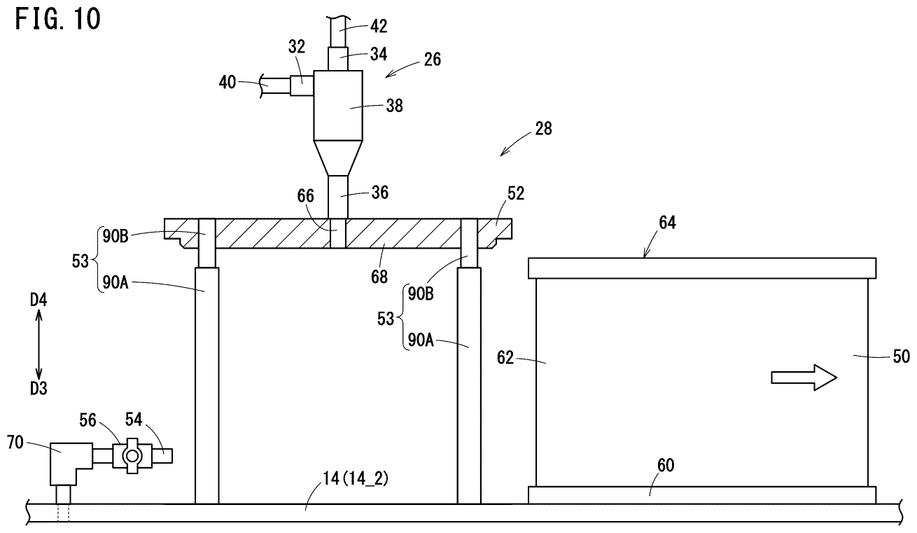

FIG. 9 is a diagram showing the separation device 26 and the storage device 28 according to a fifth modification. FIG. 10 is a diagram showing the separation device 26 and the storage device 28 with the cover 52 opened according to the fifth modification. In the present modification, the structure of the support member 53 is different from that of the embodiment.

The support member 53 includes a plurality of housing portions 90A and a plurality of sliding portions 90B. The number of the housing portions 90A is the same as the number of the sliding portions 90B. In the present modification, the number thereof is two, but may be one or three or more. The plurality of housing portions 90A have the same configuration. The plurality of sliding portions 90B have the same configuration.

The housing portions 90A each include a hole capable of housing the sliding portion 90B. The sliding portions 90B are each attached to the housing portion 90A so as to be slidable in the hole of the housing portion 90A. A first end portion of the housing portion 90A is connected to the base. A second end portion of the housing portion 90A is formed as an inlet/outlet of the sliding portion 90B. A first end portion of the sliding portion 90B is slidably connected within the hole of the housing portion 90A. A second end portion of the sliding portion 90B is connected to the cover 52.

When the sliding portions 90B respectively slide into the holes of the housing portions 90A, the support member 53 is shortened in a closing direction D3 approaching the opening portion 64. As a result, the opening portion 64 is closed by the cover 52 (see FIG. 9). In this case, the operator cannot take out the storage container 50 from between the cover 52 and the base.

On the other hand, when the sliding portions 90B respectively slide from the inside of the holes of the housing portions 90A to the outside, the support member 53 extends in an opening direction (upward direction) D4 away from the opening portion 64. As a result, the opening portion 64 is separated away from the cover 52 (see FIG. 10). In this case, the operator can take out the storage container 50 from between the cover 52 and the base.

In this manner, in the present modification, the cover 52 is attached so as to be movable in the direction (the opening direction D4 or the closing direction D3) orthogonal to the opening surface of the opening portion 64 of the storage container 50. As a result, the cover 52 can be opened without removing the cover 52 from the storage container 50. Further, the storage container 50 can be taken in and out from between the cover 52 and the base.

### Modification 6

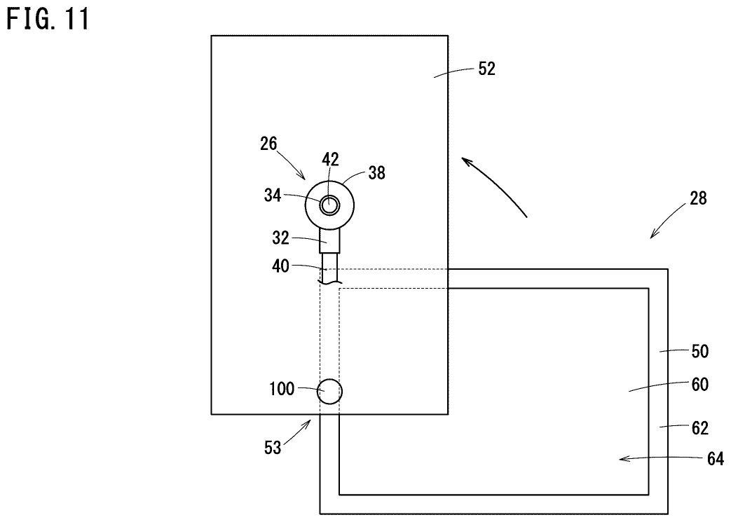

FIG. 11 is a diagram showing the separation device 26 and the storage device 28 according to a sixth modification. Incidentally, in FIG. 11, the drain member 54 is omitted. In the present modification, the structure of the support member 53 is different from that of the embodiment. The support member 53 includes a pivot shaft portion 100.

The pivot shaft portion 100 pivotably supports the cover 52 with respect to the storage container 50. The pivot shaft portion 100 is disposed along a direction orthogonal to the base surface on which the storage container 50 is disposed.

In the present modification, the cover 52 is attached to the storage container 50 by the pivot shaft portion 100 so as to be slidable along the opening surface of the opening portion 64 of the storage container 50. As a result, compared to a case where the cover 52 is opened and closed in a direction orthogonal to the opening surface of the opening portion 64 of the storage container 50, the cover 52 can be smoothly opened and closed even when the weight of the cover 52 is large.

The following supplementary notes are further disclosed in relation to the above-described embodiment.

### Supplementary Note 1

The present disclosure is the coolant system (10) that separates swarf generated by machining of the machine tool (12), from a first liquid that is a liquid containing the swarf, and supplies, to the machine tool, a second liquid that is the liquid from which the swarf has been separated. The coolant system of the present disclosure includes: the separation device (26) configured to separate, from the first liquid pumped up from the first liquid tank (14) configured to store the first liquid, the swarf contained in the first liquid; and the storage device (28) configured to store the swarf separated by the separation device. The storage device includes: the storage container (50) disposed on the base and configured to store the swarf; and the cover (52) to which the separation device is connected, the cover being configured to cover the opening portion (64) of the storage container.

According to this feature, compared to a case where a collection unit for collecting swarf is suspended from the separation device, the capacity capable of storing the swarf can be increased regardless of the weight of the storage container. As a result, the cleaning frequency can be reduced. Further, the swarf stored in the storage container can be taken out from the storage container without detaching the separation device. As a result, cleaning workability can be improved.

### Supplementary Note 2

The coolant system according to Supplementary Note 1 may further include the support member (53) configured to movably support the cover with respect to the storage container to open and close the opening portion. According to this feature, the load of moving the cover can be reduced.

### Supplementary Note 3

In the coolant system according to Supplementary Note 1 or 2, the cover may be pivotably attached to the storage container. According to this feature, the opening portion can be opened and closed without removing the cover from the storage container. As a result, the work of removing the cover is eliminated, and the workload can be reduced.

### Supplementary Note 4

In the coolant system according to Supplementary Note 1 or 2, the cover may be attached to the storage container so as to be slidable along the opening surface of the opening portion.

According to this feature, the opening portion can be opened and closed without removing the cover from the storage container. As a result, the work of removing the cover is eliminated, and the workload can be reduced. In addition, compared to a case where the cover and the storage container are connected to each other via a hinge or the like, the cover can be smoothly opened and closed even when the weight of the cover is large.

### Supplementary Note 5

In the coolant system according to Supplementary Note 1, the cover may be attached so as to be movable in a direction orthogonal to the opening surface of the opening portion. According to this feature, the opening portion can be opened and closed without removing the cover from the storage container. As a result, the work of removing the cover is eliminated, and the workload can be reduced. Further, the storage container can be taken in and out from between the cover and the base.

### Supplementary Note 6

In the coolant system according to any one of Supplementary Notes 1 to 5, the cover may include the protruding portion (68) protruding from the bottom surface of the cover, and the protruding portion may face the upper portion of the inner peripheral surface of the side wall (62) of the storage container in a state where the opening portion is closed. According to this feature, when the cover is opened in a state where the storage container is filled with a liquid such as a coolant, the liquid such as the coolant can be prevented from leaking from the opening portion.

### Supplementary Note 7

The coolant system according to any one of Supplementary Notes 1 to 6 may further include the drain member (54) provided in the storage container so as to be communicable with the inside of the storage container, and the valve (56) configured to open and close the drain member. According to this feature, it is possible to prevent the swarf and the coolant from flowing out of the storage container during the operation of the separation device. Further, the swarf, the coolant, and the like can be discharged from the storage container only during a period of cleaning, maintenance work, or the like of the storage container.

### Supplementary Note 8

The coolant system according to any one of Supplementary Notes 1 to 7 may further include the bag (72) disposed inside the storage container so as to be removable from the inside of the storage container, the swarf being put in the bag. According to this feature, the swarf can be easily taken out from the storage container, and the inside of the storage container can be kept clean.

### Supplementary Note 9

The coolant system according to any one of Supplementary Notes 1 to 8 may further include the porous filter member (76) that is disposed inside the storage container so as to be removable from the inside of the storage container, the porous filter member being configured to capture the swarf. According to this feature, the swarf can be efficiently collected by draining the liquid in the storage container from the drain member during cleaning or the like.

### Supplementary Note 10

In the coolant system according to any one of Supplementary Notes 1 to 9, the storage container may be formed in a manner so that the inside of the storage container is visible from the outside of the storage container. According to this feature, the storage state of the storage container can be checked without opening the cover.

### Supplementary Note 11

The coolant system according to any one of Supplementary Notes 1 to 10 may further include the second liquid pressure pump (22) configured to pressure-feed the second liquid to the machine tool from the second liquid tank (16) configured to store the second liquid supplied from the separation device. According to this feature, it is possible to appropriately supply the second liquid to the machine tool.

Although the present disclosure has been described in detail, the present disclosure is not limited to the above-described individual embodiments. Various additions, replacements, modifications, partial deletions, and the like can be made to these embodiments without departing from the essence and gist of the present disclosure or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

### REFERENCE SIGNS LIST

10: coolant system
12: machine tool
14: first liquid tank
16: second liquid tank
18: coolant receiving member
20: first liquid pressure pump
22: second liquid pressure pump
24: feed pump
26: separation device
28: storage device
30: porous filter member
50: storage container
52: cover
53: support member
54: drain member
56: valve
62: side wall
64: opening portion
72: bag
78: guide member

1. A coolant system that separates swarf generated by machining of a machine tool, from a first liquid that is a liquid containing the swarf, and supplies, to the machine tool, a second liquid that is the liquid from which the swarf has been separated, the coolant system comprising:
a separation device configured to separate, from the first liquid pumped up from a first liquid tank configured to store the first liquid, the swarf contained in the first liquid; and
a storage device configured to store the swarf separated by the separation device,
wherein the storage device includes:
a storage container disposed on a base and configured to store the swarf; and
a cover to which the separation device is connected, the cover being configured to cover an opening portion of the storage container.

2. The coolant system according to claim 1, further comprising:
a support member configured to movably support the cover with respect to the storage container to open and close the opening portion.

3. The coolant system according to claim 1, wherein
the cover is pivotably attached to the storage container.

4. The coolant system according to claim 1, wherein
the cover is attached to the storage container so as to be slidable along an opening surface of the opening portion.

5. The coolant system according to claim 1, wherein
the cover is attached so as to be movable in a direction orthogonal to an opening surface of the opening portion.

6. The coolant system according to claim 1, wherein
the cover includes a protruding portion protruding from a bottom surface of the cover, and the protruding portion faces an upper portion of an inner peripheral surface of a side wall of the storage container in a state where the opening portion is closed.

7. The coolant system according to any one of claim 1, further comprising:
a drain member provided in the storage container so as to be communicable with an inside of the storage container; and
a valve configured to open and close the drain member.

8. The coolant system according claim 1, further comprising:
a bag disposed inside the storage container so as to be removable from an inside of the storage container, the swarf being put in the bag.

9. The coolant system according to claim 1, further comprising:
a porous filter member disposed inside the storage container so as to be removable from an inside of the storage container, the porous filter member being configured to capture the swarf.

10. The coolant system according to claim 1, wherein
the storage container is formed in a manner so that an inside of the storage container is visible from an outside of the storage container.

11. The coolant system according to claim 1, further comprising:
a second liquid pressure pump configured to pressure-feed the second liquid to the machine tool from a second liquid tank configured to store the second liquid supplied from the separation device.
